(19) United States
(12) Patent Application Publication
(10) Pub. No.: US 2016/0174028 A1
(43) Pub. Date: Jun. 16, 2016

(54) USER IDENTIFICATION SYSTEM AND PROCESS

(71) Applicants: Muhanad Shawa, Chadstone (AU); Matthew Zwolenski, Richmond (AU)

(72) Inventors: Muhanad Shawa, Chadstone (AU); Matthew Zwolenski, Richmond (AU)

(21) Appl. No.: 14/967,225

(22) Filed: Dec. 11, 2015

(30) Foreign Application Priority Data
Dec. 14, 2014 (AU) 2014905058
Jun. 5, 2015 (AU) 2015902108

(51) Int. Cl. H04W 4/02; G06N 99/00; G06Q 30/02

(52) U.S. Cl. CPC H04W 4/02; G06Q 30/0261; G06N 99/005

(57) ABSTRACT

At least one non-transitory computer-readable storage medium having stored thereon processor-executable instructions that, when executed by at least one processor of a computing device or system, cause the at least one processor to execute a process for automatically providing or offering services and/or products targeted to one or more individuals, the process including the steps of: for each of one or more individuals in a corresponding location, receiving a corresponding identifier of the individual, the identifier being received from a portable device in possession of the individual via a wireless communications interface of the portable device; processing the received identifiers to retrieve, for each of the one or more individuals, corresponding user data representing services and/or products previously selected by and/or of interest to the individual; and providing or offering at least one service and/or product targeted to the one or more individuals, based on the retrieved user data.

### INCORPORATION BY REFERENCE TO ANY PRIORITY APPLICATIONS

This application claims the benefit of Australian Patent Application No. 2014905058, filed on Dec. 14, 2014, and Australian Patent Application No. 2015902108, filed on Jun. 5, 2015, in the Australian Intellectual Property Office, the disclosures of which are incorporated herein in their entirety by reference.

### TECHNICAL FIELD

The present disclosure relates to a user identification system and process.

### BACKGROUND

There are many situations in which it would be desirable to customise or tailor aspects of an environment or location to the individuals in that environment, including the provision of (or at least offering to provide) products and/or services targeted to those individuals in that location.

It is desired to alleviate one or more difficulties of the prior art, or to at least provide a useful alternative.

### SUMMARY

In accordance with some embodiments, there is provided a process for automatically providing or offering services and/or products targeted to one or more individuals, the process including the steps of:
for each of one or more individuals in a corresponding location, receiving a corresponding identifier of the individual, the identifier being received from a portable device in possession of the individual via a wireless communications interface of the portable device;
processing the received identifiers to retrieve, for each of the one or more individuals, corresponding user data representing services and/or products previously selected by and/or of interest to the individual; and
providing or offering at least one service and/or product targeted to the one or more individuals, based on the retrieved user data.

In some embodiments, the portable device in possession of the individual automatically transmits the corresponding identifier of the individual via the wireless communications interface of the portable device without involvement of the individual.

In some embodiments, the one or more individuals includes a plurality of individuals, and the process includes processing the retrieved user data of the plurality of individuals to generate corresponding group data representative of corresponding services and/or products of interest to the plurality of individuals, considered collectively as a group; and wherein the step of providing or offering includes providing or offering the at least one service and/or product collectively targeted to the plurality of individuals, based on the generated group data.

In some embodiments, the step of providing or offering at least one service and/or product includes playing, in the location, corresponding items of media targeted to the individuals.

In some embodiments, the items of media include items of music. In some embodiments, the services and/or products previously selected by the individual include music preferences of the individual.

In some embodiments, the process includes determining information specific to the location and processing the determined information and the retrieved user data to determine the at least one service and/or product targeted to the one or more individuals.

In some embodiments, the determining of information specific to the location includes determining a position of the individual relative to a boundary of the location.

In some embodiments, the process includes processing the determined position of the individual to determine information indicative of the individual entering or leaving a pre-determined geo-boundary.

In some embodiments, the determining of information specific to the location includes determining an audio level of the location. In some embodiments, the determining of information specific to the location includes determining an economic or social activity of at least one of the identified individuals.

In some embodiments, the process includes applying a statistical or machine learning based analysis to the retrieved user data.

In accordance with some embodiments, there is provided a process for automatically generating a music playlist targeted to one or more individuals, the process including the steps of:
for each of one or more individuals in a corresponding location, receiving a corresponding identifier of the individual, the identifier being received from a portable device in possession of the individual via a wireless communications interface of the portable device;
processing the received identifiers to retrieve, for each of the one or more individuals, corresponding user data representing music preferences of the individual;
processing the user data of the individuals to generate corresponding group data representative of corresponding music preferences of the plurality of individuals, considered collectively as a group; and
playing, to the one or more individuals, items of music targeted to the individuals based on the retrieved user data.

In some embodiments, the one or more individuals includes a plurality of individuals, and the process includes processing the retrieved user data of the plurality of individuals to generate corresponding group preference data representing music preferences of the plurality of individuals, considered collectively as a group; and wherein the items of music are collectively targeted to the group of individuals based on the generated group preference data.

In accordance with some embodiments, there is provided at least one computer-readable storage medium having stored thereon processor-executable instructions that, when executed by at least one processor of a computing device or system, cause the at least one processor to execute any one of the processes described above.

In accordance with some embodiments, there is provided a system for automatically providing or offering services and/or products targeted to one or more individuals, the system including:
at least one processor; and
at least one memory component in communication with the at least one processor;
wherein the system is configured to cause the at least one processor to execute any one of the processes described above.

In accordance with some embodiments, there is provided a system for automatically providing or offering services and/or products targeted to one or more individuals in a location, the system including:
a local component of a first location in which the one or more individuals are located; and
at least one server component;
wherein the local component and the at least one server component are in mutual communication via at least one communications network;
wherein the local component is configured to receive, for each of one or more individuals in the first location, a corresponding identifier of the individual, the identifier being received from a portable device in possession of the individual via a wireless communications interface of the portable device;
wherein the at least one server component is configured to retrieve, for each of the one or more individuals, and on the basis of the corresponding identifier of the individual, corresponding user data representing services and/or products previously selected by and/or of interest to the individual; and
wherein the local component is configured to provide or offer at least one service and/or product targeted to the one or more individuals, based on the retrieved user data.

In some embodiments, the at least one server component is located in a second location remote from the first location.

### BRIEF DESCRIPTION OF THE DRAWINGS

Some embodiments are hereinafter described, by way of example only, with reference to the accompanying drawings, wherein:

FIG. 1 is a schematic diagram of a user identification system in accordance with an embodiment;

FIG. 2 is a flow diagram of a user registration process of the user identification system;

FIG. 3 is a flow diagram of a vendor registration process of the user identification system;

FIG. 4 is a flow diagram of a user identification process of the user identification system;

FIG. 5 is a schematic diagram illustrating the wireless detection of users by the user identification system; and

FIG. 6 is a block diagram of a computer system used to implement the local device and/or the server components of the user identification system in the described embodiments.

### DETAILED DESCRIPTION

Embodiments include a user identification system and process that enable the automatic identification of individual users in a location so that one or more aspects of the local environment can be automatically customised to those identified users, based on stored information about those users.

The identification of each user is performed by automatically and wirelessly retrieving an identifier of the user from a portable device in the possession of that user. The retrieved identifier is then used to look up stored information about that user, and that information is then used to customise aspects of the user's local environment or experience. In cases where the customisation is effectively shared or experienced by multiple individuals in the same location or local environment, the customisation is typically determined by a combination of the information about the user and corresponding information for other identified users in that location or local environment.

Some embodiments further allow the identified users to influence the customisation by way of application software installed on the users' portable devices.

Some embodiments also provide means to determine relationships between the customised aspects of the environment and concurrent sales of products and/or services in the location, where the location is a commercial location such as a shop, cafe, or restaurant, for example. These relationships can then be used to further influence the customisation with the aim of increasing sales. As described below, other inputs can additionally or alternatively be used to influence the customisation, for example by using sensors to assess the mood of the users in the location, particularly in response to the customisation.

In the embodiments described below, the aspect of the local environment that is customised or tailored to one or more targeted occupants of a location is the music or audio that is played or broadcast in the location or environment, based on music preference data of each of those occupants. However, it will be apparent that, once the users present in a location have been identified, almost any aspect of the environment can be customised to those users, providing that relevant information of those users is available. For example, the stored information of each user can include products and/or services of interest to that user (whether previously purchased, or in at least one ‘wish list’), and that information can then be used to offer and/or provide related products and/or services to the user.

An embodiment will now be described in the context of a user identification system and process for customising an audio or music environment of a location or environment, based on determining music preferences of identified users that are present in that location at any given time. The location is described as being a commercial location such as a shop or café, but it will be apparent to those skilled in the art that the system can be used in essentially any location or environment, including in a domestic home setting, for example.

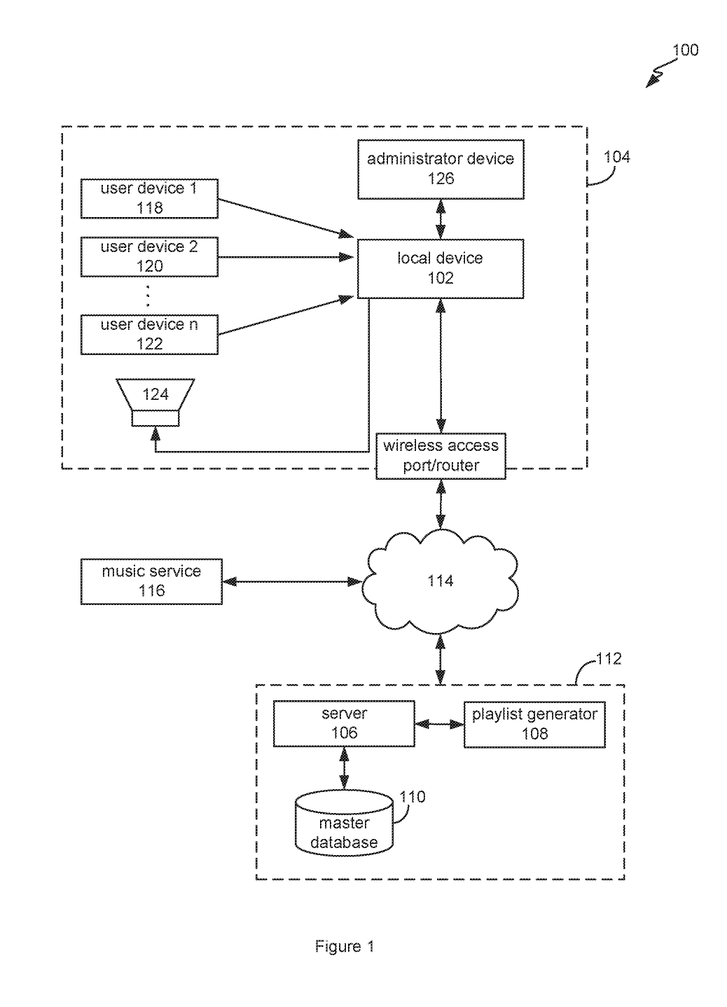

As shown in FIG. 1, the user identification system 100 includes a local device 102 that is installed in the location 104, which in this example is described as being a café, and server components 106, 108, 110 which are typically (but not necessarily) installed at a remote (e.g., centralised) location 112. The local device 102 and the server components 108 to 110 communicate via a communications network, such as the Internet 114.

In the described embodiment, the source of the music/audio is at least one third party music service 116 such as Spotify, Pandora, rdio, mog, tidal, and the like, and consequently the user identification system 100 is also in communication with the corresponding music server(s) 116 of this service via the communications network 114. However, other embodiments may rely on any other source(s) of music/audio, including a local repository of music files at the location 104, for example. Such other source(s) of music/audio may be used as an alternative to, or in combination with, at least one third party music service 116.

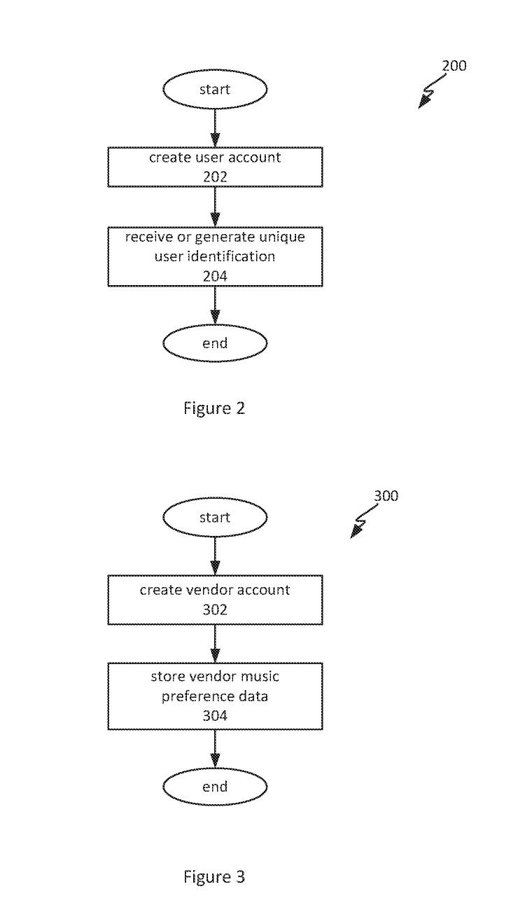

In order to use the user identification system 100, a person needs to register themselves with the system 100 using a user registration process 200, as shown in FIG. 2. This process begins by creating a user account at step 202, involving the user creating a unique username and password. In the described embodiment where a third-party music service is used as the source of music/audio, the user also provides to the system 100 the username and password of their account with the relevant third party music service so that the user identification system 100 can access the user's music preference information from that service. The system 100 performs authentication with the third party service 116 via an API call provided by the third party music service 116. The user's registration data is stored in a database 110 of the server components 112.

In the described embodiment, at step 204, a unique (or at least nominally unique) user identifier is either provided to the system 100 or generated by the system 100. In the described embodiment, and most conveniently, the user identifier is the unique hardware address of a wireless networking interface of the user's portable device, generally known in the art as the ‘MAC’ (media access control) address of that interface. In the described embodiment, the wireless networking interface is an IEEE 802.11 (or ‘Wi-Fi’) wireless networking interface; however, the MAC address may alternatively be the MAC address of a different type of wireless networking interface; such as a Bluetooth Classic or Bluetooth LE/Smart interface, for example. Moreover, other types of identifiers (hardware or otherwise) can be used in other embodiments. In particular, in some embodiments, the system 100 can generate a nominally unique random number as the identifier. In any case, the identifier is stored in association with the user's other information in the database 110, so that it can be used to identify the user's account with the system 100, and therefore retrieve the user's music preference information from a corresponding music service server 116. Alternatively, the user's username and password pair for the user identification system 100 can be used to retrieve that user's music service registration information.

In order for a person or business to be able to use the system 100 to customise one or more aspects of an environment/location 104, that person or business also needs to register with the system 100. In the described embodiment, where the location 104 is a cafe, that person or business is referred to hereinafter as a “vendor”. As shown in FIG. 3, a vendor or registration process 300 begins by creating a vendor or account with the system 100 at step 302. At step 304, the vendor selects or otherwise provides vendor music preference data that provides the default music preference information for the vendor's location (café) in the absence of, or in combination with, the music preferences of registered users in the cafe. This music preference information can be in the form of one or more preferred genres of music, performers, and/or songs, for example.

The vendor also needs to install the local device 102 in the café. Typically, this will involve the vendor or purchasing the local device 102 from the operator of the user identification system 100. Alternatively, the vendor may install application software provided by the operator of the user identification system 100 on a local computing device owned by the vendor to provide the local device 102.

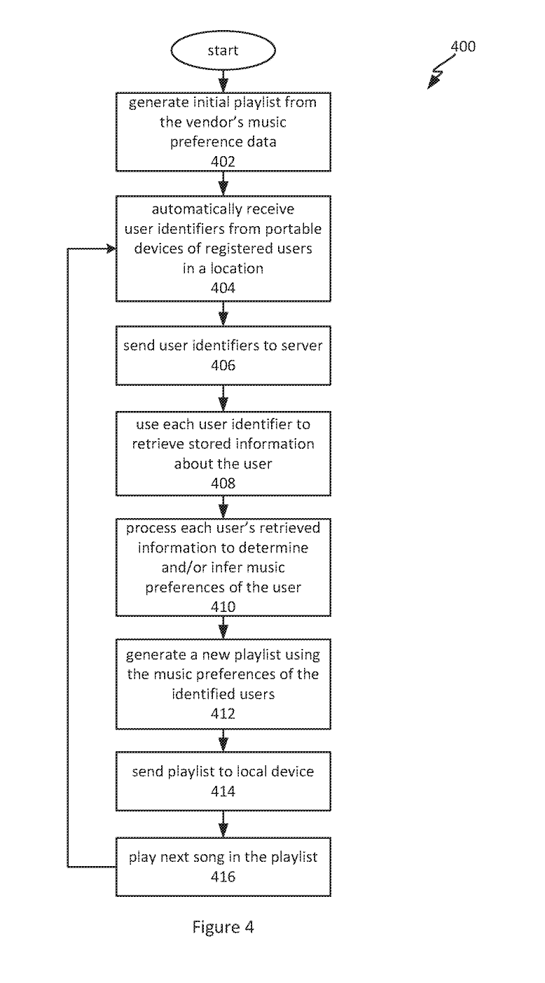

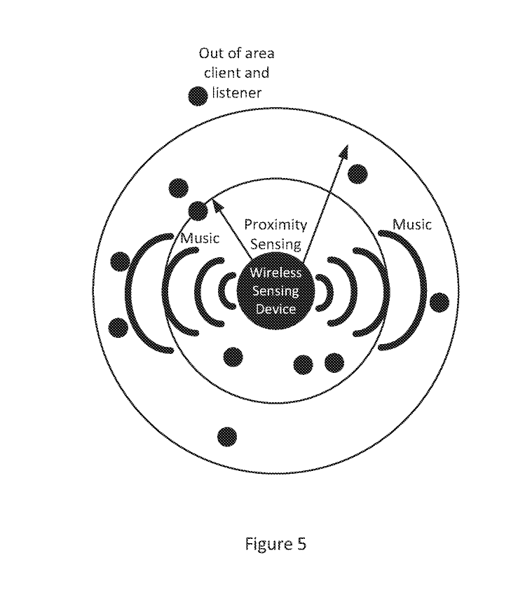

On startup, the local device 102 executes a user identification process, as shown in FIG. 4. This process begins by generating an initial playlist at step 402, based on the vendor's music preference information stored with the system 100, as described above. In the described embodiment, where the source of the music/audio is a third-party music service 116, the vendor also has an account with the third-party music service 116, and the initial playlist may be also stored with that service 116. This playlist then begins playing or broadcasting to any and all occupants of the vendor's café by communicating with the third-party music service 116 via its API. For example, if the vendor subscribes to the Spotify music streaming service, then the local device 102 can call the Spotify API to stream music from Spotify to the vendor's café. This service provides the corresponding music data, and generating an audio output from this music data by way of the local device 102 executing an appropriate client application to access the music service 116, and music playback hardware 124, including an amplifier and speaker. The local device 124 can be a mobile (smart) phone, a computer, a web connected music system such as a Sonos system, or any other device that is capable of accessing streamed music from the internet.

The local device 102 periodically determines (at step 404) the user identifiers that are automatically transmitted by the portable wireless devices in possession of any registered users of the system 100 that are present in the vendor's café 104. Where the user identifiers are provided by MAC addresses of the IEEE 802 interfaces of the portable devices, these are automatically transmitted as part of the standard wireless network polling performed by these devices.

Alternatively, the user identifiers can be automatically transmitted from the user's portable devices under control of application software provided by the operator of the system 100 and executing as a background process on each user's portable device. In some embodiments, the user identifier is automatically transmitted by the user's portable device in response to receipt of an iBeacon advertisement from an iBeacon of the local device 102.

Although in the described embodiment the user identifiers are transmitted from the portable devices to the local device 102 using an IEEE 802.11 ‘Wi-Fi’ networking protocol, it will be apparent that other wireless networking protocols, methods and devices can be used in other embodiments, including, for example, Bluetooth LE/Smart, Bluetooth Classic, Zigbee, NFC, and the like.

Regardless of the nature of the user identifiers, the local device 102 periodically generates a list of all of the user identifiers received in the corresponding period, representing the registered users of the system 100 that are present in the vendor's cafe at that time.

At step 406, the user identifiers are sent to the server 106, which stores them in the database 110. At step 408, the server 106 processes each of the received user identifiers in order to retrieve from the database 110 the corresponding user's stored information. Typically, this information includes music preference information for the user that has been previously stored in the database 110. However, if there is no such information in the database 110 (for example, the particular user has not been previously identified by the system 100), or if the stored music preference information is out of date (e.g., it was stored more than one week earlier), then it may be necessary to retrieve music preference information for that user from the user's account with the third-party music service 116. In this case, the information retrieved from the database 110 at step 408 includes the username and password of the user's music service registration, and the server 106 then uses that user's music service registration information to retrieve from the music service 116 that user's music preference data, which is then stored in the database 110.

At step 410, the music preferences of each user are determined from the information retrieved from the database 110 for that user at step 408. The retrieved information includes music preference information, but typically also includes other information can be used to infer the user's music preferences, including the persons ratings of songs that are playing, playlists saved by that user, information collected during machine learning cycles (for example, whether the user stayed longer when a particular song was played), and correlations with other identified users and their respective music preferences.

Each user's music service playlists and/or preferences are updated periodically from the music service 116 to ensure that locally stored playlist/preference information reflects each user's current preference in music. The playlist/preference information of each user can be updated at scheduled times (e.g., weekly or monthly) or in response to the user being identified by the system 100 and that user's information not having been updated within an administrator-configurable period of time (e.g., one week). The locally stored information 418 can additionally include determinations of user preferences of songs based on user ratings, information collected during machine learning cycles, and/or measures of music preference correlation between one or more users, as described below.

Once the music preference data for each of the identified users has been retrieved from the corresponding music service server 116, the server 106 provides all of the retrieved data to a playlist generator 108, which generates at step 412 a corresponding playlist based on the collective music preference data of all of the identified users, as will be described in more detail below.

At step 414, the generated playlist is sent to the local device 102, and at step 416, the generated playlist commences playing, after the currently playing track or song has completed. The application server 106 causes the playlist items to commence playing via an API call to the music service 116. The music service 116 then transmits the music data for each song/track of the generated playlist to the local device 102, which enables the song to be broadcast through the playback hardware 124. The user identification process 400 then loops back to repeat steps 404 to 416.

It will be apparent from the description above that the user identification system 100 and process 400 allow the music playlist for the vendor's café to be dynamically and automatically updated so that the music or audio playing in the cafe at any given time reflects the musical interests or preferences of the occupants of the cafe at that time, insofar as those occupants are registered users of the user identification system 100. Consequently, those occupants are more likely to find the café more comfortable or appealing, and thus spend more time (and money) in the cafe. A particularly advantageous aspect is that each user's musical preferences are automatically retrieved and processed without requiring the user to perform any manual activities or even to be aware of these processes.

The user identification system 100 process 400 can also be used in selected areas of shopping centres, in transport vehicles such as buses, coaches, limousines, and at parties, events or gatherings where the host wishes to target music playlists to guests or attendees. Many other applications of the system 100 and process 400 will be apparent to those skilled in the art in light of this disclosure.

Depending on the physical configuration of the vendor's café (or other location), it will be apparent that the user identification system 100 and process 400 can also generate playlists from the musical preferences of users located outside the physical boundaries of the cafe, but within range of the wireless communications between the users' portable devices and the local device 102. This ability can make the cafe more likely to attract new customers as they approach the café and hear music that they like playing in the cafe. Moreover, by determining the relative proximity of such users to cafe using standard wireless networking processes, the system 100 can even bias the generated playlists toward such users relative to customers already within the cafe boundaries. However, such behaviour of the system 100 can be customised by the vendor via an administrator device 126, in the described embodiment being the vendor's personal mobile telephone with administration software of the system 100 installed thereon.

User Control and Feedback

In some embodiments, the playlist generation process 412 can also take into account locally determined information in addition to previously stored user preference data when generating playlists. Specifically, the playlist generator 108 can take into account one or more of the following:
(i) the proximity of users to the local device 102;
(ii) the location of the user in relation to one or more predetermined geo-boundaries within the location 104, as detected by one or more wireless sensing devices of (or otherwise associated with) the local device 102; and
(iii) one or more consumption metrics, such as sales or revenue, allowing the determination of relationships between these metrics and characteristics of the playlists being played at corresponding times.

The system 100 can determine information relating to the location, within the operating location 104, of one or more identified users, based on the proximity of these users to the local device 102. User location information may be determined using predetermined knowledge of the location of the local device 102 and standard wireless location detection methods, such as iBeacon, for example. Accordingly, the system 100 can determined an identified user's approximate proximity to specific objects, sub-areas or locations within the location 104. Additionally or alternatively, the local device 102 can include location sensing devices deployed at predetermined geo-locations. In general, if one or more of these location sensors detects an identified user within a corresponding operating environment 104, then the user's position relative to at least one boundary of the location can be determined or inferred by the local device 102.

Such geo-positional information can be used by the system 100 to determine the position of detected users relative to at least one boundary of the location. The geo-position information of a user can be obtained from several sources, including: i) the determined detection information of the user relative to the local device 102, as described above; and ii) an explicit indication, received from the user, of the user's geo-position in accordance with measurements obtained from an external geographical information source. The geographical information source can include, for example, one or more satellites implementing the Global Positioning Satellite System (GPS), or similar navigation systems including the Global Navigation Satellite System (GNSS), Galileo, GLONAS or Beibou-2. The database 110 can be configured with knowledge of the geo-boundaries of the location 104. The system server 106 is configurable to retrieve geo-boundary data from the database 110 and to process the determined geo-position information of each identified user in order to determine whether the user enters or leaves a corresponding region defined by the retrieved geo-boundary.

Standard analysis methods known to those skilled in the art, such as adaptive machine learning or statistical classification, can be employed by the playlist generator 108 in some embodiments to influence the generation of music playlists at step 412, based on the extent to which previously played songs accurately satisfy collective user preferences or increase sales or revenue.

In some embodiments, the system 100 allows users within the location 104 to provide direct feedback of their preferences for or against specific songs and/or playlists via their portable devices 118-122. Users identified within the location 104 can express their music preferences via an application program executing on their portable device 118-122. For example, the user may choose to rate the currently playing song by selecting a ‘Rate song’ option and rating the current song with a numerical value, quantifying the extent of their like or dislike for the song within a predefined preference range. Alternatively, the user can indicate a preference for the song on a binary ‘like’ or ‘dislike’ scale. The local device 102 receives this music preference information supplied by the users, and transmits this information to the server 106, where it is used in conjunction with other preference information to influence the generation of playlists 412. In the absence of specific information about a user's preference of a specific song, correlation based methods can be employed to infer the song preference of the user based on the corresponding preferences of users with similar profiles or similar ‘likes’ expressed toward other songs.

In some embodiments, the system 100 also allows a user to capture and view the current playlist on their portable device 118 to 120, and to allow playback of the songs of the captured playlist at a later time. For example, a user at a café can use this feature to view and save a list of the songs of the current playlist. In response to a request from a registered user's portable device 118 to 120 to capture the current playlist, the local device 102 transmits the request to the server 106, which then determines the specific location 104 of the corresponding user from the users identifier (or registration information), and hence the current playlist for that location 104. The playlist is then forwarded to the requesting application executing on the user's portable device 118 to 120. The user application may provide options by which the user can obtain the playlist songs, including purchasing licenses to download the music files, or integrating one or more selected songs of the captured playlist into the user's music service 116 account.

Given the availability of music preference information from the music services 116 and the locally inferred preference information obtained from the location 104, the playlist generator 108 can combine these two types of information to generate a playlist that satisfy the collective preference of the registered users in the location 104, including accounting for changes in those registered users in the location 104 over time. Most trivially, the system 100 can simply combine the music preferences of all registered users in the location 104 to generate playlists from the aggregated music preferences of all those users. However, the music preference data can be processed in more sophisticated ways to provide group preference data that is more representative of the occupants at any given time, considered as a group, or otherwise provides more flexibility in playlist generation, whilst remaining based on the actual preferences of the location occupants at relevant times. For example, in some embodiments the playlist generator 108 can perform various types of statistical analyses of the preference data of the users.

In some embodiments, group preference data is generated as a weighted average of the preference data of the occupants. The collective (i.e. ‘overall’) group preference of a song is determined as the product of the preference of an identified user towards the song multiplied by the relative contribution weight of this user's preference to the collective preference (to the same song) of the group consisting of all identified users in the location 104. If a user has no inferred or known preference for a particular song, then a ‘neutral’ value, such as the midpoint value within the inferred preference score range, can be used in the determination.

Given the group preference score of each song of a playlist, a group preference score value for the playlist can be determined, for example by summing the individual group preference scores of songs comprising the playlist. The preferences of at least one individual user can be biased or weighted over the preference of other users, based on one or more factors such as, for example, the at least one user having a higher status than the other users (e.g., being a premium subscriber where the other users are not), the at least one user spending more than the other users, or being a more frequent (or less frequent) visitor to the cafe than the other users. Many alternative methods and techniques for determining group preferences based on the individual target users' preferences will be apparent to those skilled in the art in light of this disclosure, including pattern classification and regression analysis, for example. The playlist generation module 108 is thus easily extendible to incorporate such methods, and to allow further configurability by the vendor over the methods of determine group preferences.

Ranked lists of songs, playlists, themes, and mood items may be used by the playlist generator 108 to generate dynamic playlists that satisfy group preferences over time. For example, a plurality of songs may be selected to form the group playlist using the individual preference rankings of those songs for the identified occupants. The playlist generator 108 can also further increase the ranking or popularity of each song in which the ranking or popularity of that song as initially determined by the system 100 is correlated with the ranking or popularity of that song by the music service 116. The playlist generator 108 can exclude from the generated playlists any songs that have been played within a predetermined period of time defined by the vendor or an administrator of the system 100.

In some embodiments, the local device 102 can monitor audio levels within the location 104 using a sensor such as a microphone to influence the selection of the next song to be played from the playlist (at step 416). For example, a positive preference of users to a song can be inferred if the measured audio levels significantly increase in response to that song being played. Conversely, if the noise levels in the location 104 decline when a particular song is played, then this can be deemed to be an indicator of a less preferred song.

in some embodiments, a registered user of the system 100 can request a particular music item or song to be played via a ‘jukebox’ mode feature. The user may select a song, band, music style, theme, mood or genre that they specifically want played via a jukebox option of the application executing on that user's portable device 118-122. The local device 102 receives these ‘play requests’ from users in the location 104, and these requests can prompt the local device 102 to immediately play the requested song(s) or may result in the specific song(s) to be queued for playing (as in step 416) The system 100 is operable to provide this service as an exclusive option for ‘premium’ users, where competing requests for songs are resolved in a first-in first-played manner. Other arbitration mechanisms can be employed in alternative embodiments, including, for example, limiting the number of music selections made by a user, as configured by the system administrator.

The functionality of the system 100 is configurable by a local or global administrator user who can access the local device 102 and/or central server 106 via an administrator device 126, which is typically a portable computing device such as a mobile phone or tablet computer on which administrator software of the system 100 has been installed.

In this way, a local administrator can manage the usage rights of ordinary users registered with the system 100 in the location 104. For example, the local administrator can designate an ordinary registered user as a ‘music master’ in that location 104, allowing that user to have:
i) a stronger influencing control over the playlist; and/or
ii) the ability to perform all administration functions, such as queue specific songs, delete songs from the playlist, choose themes, genres, bands and moods.

The local administrator can also add and remove ordinary users from an exclusion list. Existing preferences of users on the exclusion list will not be considered in the determination of the music playlist, and the received preference information for these users will not be recorded by the system.

An administrator user can create new predefined music playlists, themes and moods for use by the system.

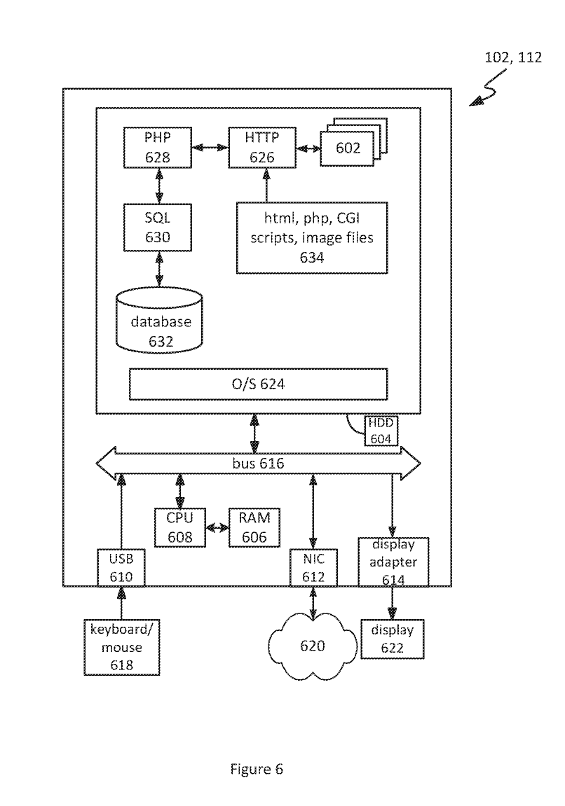

In the described embodiment, each of the local device 102 and the server components 112 is a standard computer system such as an Intel Architecture IA-32 or IA-64 based computer system, as shown in FIG. 6, and the process 400 executed by the system 100 is implemented as programming instructions of one or more software modules stored on non-volatile (e.g., hard disk or solid-state drive) storage 604 associated with the corresponding computer system, as shown in FIG. 6. However, it will be apparent that at least parts of the process 400 could alternatively be implemented as one or more dedicated hardware components, such as field programmable gate arrays (FPGAs) and associated configuration data, or application-specific integrated circuits (ASICs), for example.

Each computer system includes random access memory (RAM) 306, at least one processor 608, and external interfaces 610, 612, 614, interconnected by at least one bus 616. The external interfaces include universal serial bus (USB) interfaces 610, at least one of which is connected to a keyboard 618 and a pointing device such as a mouse 619, a wireless network interface connector (NIC) 612 which connects the system 100 to the communications network 620, and a display adapter 614, which may be connected to a display device such as an LCD panel display 622.

The computer systems also include a number of standard software modules 626 to 630, including an operating system 324 such as Linux or Microsoft Windows. In some embodiments, the local device 102 includes web server software 626 such as Apache, available at http.//www.apache.org, scripting language support 628 such as PHP, available at http://www.php.net, or Microsoft ASP. The server components computer 112 includes structured query language (SQL) support 630 such as MySQL, available from http://www.mysql.com, which allows data to be stored in and retrieved from an SQL database 632.

Many modifications will be apparent to those skilled in the art without departing from the scope of the present invention.

1. At least one non-transitory computer-readable storage medium having stored thereon processor-executable instructions that, when executed by at least one processor of a computing device or system, cause the at least one processor to execute a process for automatically providing or offering services and/or products targeted to one or more individuals, the process including the steps of:
for each of one or more individuals in a corresponding location, receiving a corresponding identifier of the individual, the identifier being received from a portable device in possession of the individual via a wireless communications interface of the portable device;
processing the received identifiers to retrieve, for each of the one or more individuals, corresponding user data representing services and/or products previously selected by and/or of interest to the individual; and
providing or offering at least one service and/or product targeted to the one or more individuals, based on the retrieved user data.

2. The computer-readable storage medium of claim 1, wherein the portable device in possession of the individual automatically transmits the corresponding identifier of the individual via the wireless communications interface of the portable device without involvement of the individual.

3. The computer-readable storage medium of claim 1, wherein the one or more individuals includes a plurality of individuals, and the process includes processing the retrieved user data of the plurality of individuals to generate corresponding group data representative of corresponding services and/or products of interest to the plurality of individuals, considered collectively as a group; and wherein the step of providing or offering includes providing or offering the at least one service and/or product collectively targeted to the plurality of individuals, based on the generated group data.

4. The computer-readable storage medium of claim 2, wherein the one or more individuals includes a plurality of individuals, and the process includes processing the retrieved user data of the plurality of individuals to generate corresponding group data representative of corresponding services and/or products of interest to the plurality of individuals, considered collectively as a group; and wherein the step of providing or offering includes providing or offering the at least one service and/or product collectively targeted to the plurality of individuals, based on the generated group data.

5. The computer-readable storage medium of claim 3, wherein the step of providing or offering at least one service and/or product includes playing, in the location, corresponding items of media targeted to the individuals.

6. The computer-readable storage medium of claim 5, wherein the items of media include items of music.

7. The computer-readable storage medium of claim 6, wherein the services and/or products previously selected by the individual include music preferences of the individual.

8. The computer-readable storage medium of claim 1, including determining information specific to the location and processing the determined information and the retrieved user data to determine the at least one service and/or product targeted to the one or more individuals.

9. The computer-readable storage medium of claim 7, including determining information specific to the location and processing the determined information and the retrieved user data to determine the at least one service and/or product targeted to the one or more individuals.

10. The computer-readable storage medium of claim 8, wherein the determining of information specific to the location includes determining a position of the individual relative to a boundary of the location.

11. The computer-readable storage medium of claim 8, including processing the determined position of the individual to determine information indicative of the individual entering or leaving a pre-determined geo-boundary.

12. The computer-readable storage medium of claim 8, wherein the determining of information specific to the location includes determining an audio level of the location.

13. The computer-readable storage medium of claim 8, wherein the determining of information specific to the location includes determining an economic or social activity of at least one of the identified individuals.

14. The computer-readable storage medium of claim 8, including applying a statistical or machine learning based analysis to the retrieved user data.

15. At least one non-transitory computer-readable storage medium having stored thereon processor-executable instructions that, when executed by at least one processor of a computing device or system, cause the at least one processor to execute a process for automatically generating a music playlist targeted to one or more individuals, the process including the steps of:
for each of one or more individuals in a corresponding location, receiving a corresponding identifier of the individual, the identifier being received from a portable device in possession of the individual via a wireless communications interface of the portable device;
processing the received identifiers to retrieve, for each of the one or more individuals, corresponding user data representing music preferences of the individual;
processing the user data of the individuals to generate corresponding group data representative of corresponding music preferences of the plurality of individuals, considered collectively as a group; and
playing, to the one or more individuals, items of music targeted to the individuals based on the retrieved user data.

16. The computer-readable storage medium of claim 15, wherein the one or more individuals includes a plurality of individuals, and the process includes processing the retrieved user data of the plurality of individuals to generate corresponding group preference data representing music preferences of the plurality of individuals, considered collectively as a group; and wherein the items of music are collectively targeted to the group of individuals based on the generated group preference data.

17. A system for automatically providing or offering services and/or products targeted to one or more individuals, the system including:
at least one processor; and
at least one memory component in communication with the at least one processor;
wherein the system is configured to cause the at least one processor to execute a process for automatically providing or offering services and/or products targeted to one or more individuals, the process including the steps of:
for each of one or more individuals in a corresponding location, receiving a corresponding identifier of the individual, the identifier being received from a portable device in possession of the individual via a wireless communications interface of the portable device;
processing the received identifiers to retrieve, for each of the one or more individuals, corresponding user data representing services and/or products previously selected by and/or of interest to the individual; and
providing or offering at least one service and/or product targeted to the one or more individuals, based on the retrieved user data.

18. A system for automatically providing or offering services and/or products targeted to one or more individuals in a location, the system including:
a local component of a first location in which the one or more individuals are located; and
at least one server component;
wherein the local component and the at least one server component are in mutual communication via at least one communications network;
wherein the local component is configured to receive, for each of one or more individuals in the first location, a corresponding identifier of the individual, the identifier being received from a portable device in possession of the individual via a wireless communications interface of the portable device;
wherein the at least one server component is configured to retrieve, for each of the one or more individuals, and on the basis of the corresponding identifier of the individual, corresponding user data representing services and/or products previously selected by and/or of interest to the individual; and
wherein the local component is configured to provide or offer at least one service and/or product targeted to the one or more individuals, based on the retrieved user data.

19. The system of claim 18, wherein the portable device in possession of the individual automatically transmits the corresponding identifier of the individual via the wireless communications interface of the portable device without involvement of the individual.

20. The system of claim 19, wherein the local component is configured to play, in the location, corresponding items of media targeted to the individuals.
